(19) United States
(12) Patent Application Publication
(10) Pub. No.: US 2024/0112656 A1
(43) Pub. Date: Apr. 4, 2024

(54) KEY WEIGHT AND KEY FOR KEYBOARD INSTRUMENT

(71) Applicant: KABUSHIKI KAISHA KAWAI GAKKI SEISAKUSHO, Hamamatsu-shi (JP)

(72) Inventor: Takuma MURAI, Hamamatsu-shi (JP)

(21) Appl. No.: 18/473,065

(22) Filed: Sep. 22, 2023

(30) Foreign Application Priority Data
Sep. 30, 2022 (JP) 2022-157247

(51) Int. Cl. G10H 1/34

(52) U.S. Cl. CPC G10H 1/346; G10H 2220/221; G10H 2220/265

(57) ABSTRACT

A key weight for a key of a keyboard instrument includes a weight body, a guide portion extending in a vertical direction and further downward than a front surface of the weight body, and a pair of left and right first latched portions provided at the respective lower portions of opposite side surfaces of the guide portion. When the key weight is pushed into a weight-accommodating portion of the key in a state in which the pair of first latched portions are in contact with key-side latching portions, the lower portion of the guide portion is elastically deformed by reaction forces from the key-side latching portions such that the lower portion is bent rearward. Then, the lower portion of the guide portion is restored by disappearance of the reaction forces, whereby the first latched portions are latched with the key-side latching portions from below.

### BACKGROUND OF THE INVENTION

### Field of the Invention

The present invention relates to a key weight which is applied to a keyboard device for a keyboard instrument, such as an electronic piano, and is mounted in a key so as to obtain a desired touch weight given during key depression, and the key for the keyboard instrument, in which the key weight is mounted.

### Description of the Related Art

Conventionally, as a key weight and a key for a keyboard instrument of the above-mentioned type, there have been known, for example, ones disclosed in Japanese Laid-Open Patent Publication (Kokai) No. 2017-44988 already filed by the present applicant. This key weight is formed of rubber mixed with iron powder, and includes a weight body having a rectangular parallelepiped shape, ridge portions which are formed in lower portions of opposite left and right side surfaces of the weight body and each include a plurality of ridges arranged side by side in a vertical direction, and a coming-off prevention portion formed to protrude from a lower portion of a front surface of the weight body and having a wedge shape in side view. On the other hand, the key is a black key extending in a front-rear direction, and has a front end thereof formed with a weight accommodating portion (hole portion in Japanese Laid-Open Patent Publication (Kokai) No. 2017-44988) which is open downward and in which the key weight is mounted. Further, the key has a hooking portion formed at a front portion of an opening of the weight accommodating portion.

During manufacturing of the key, when the above-described key weight is mounted in the key, the key weight is pushed into the weight accommodating portion from below the key. In this case, the wedge-shaped coming-off prevention portion of the key weight itself gets over the hooking portion of the key upward from below while being elastically deformed and is latched with the hooking portion from below. Further, the left and right ridge portions of the key weight are elastically deformed while being sandwiched between the weight body and the left and right side walls of the weight accommodating portion, and by thrust due to returning forces of the elastically deformed ridge portions, the key weight is fixed to the front end of the key. Thus, the key weight, described above, is configured to be capable of being easily mounted in the key only by being pushed into the weight accommodating portion of the key.

The above-described key weight mounted in the key is fixed to the weight accommodating portion of the key by the thrust due to the left and right ridge portions and the latching of the coming-off prevention portion at the lower portion of the front surface of the key weight with the hooking portion. However, if the returning forces due to the elastic deformation of the ridge portions are reduced or the coming-off prevention portion is twisted in a left-right direction e.g. by a long-term use of the keyboard instrument, there is a fear that the key weight is displaced downward or falls off the key. Further, depending on the shape and size of the key weight and the posture of the key weight with respect to the weight accommodating portion, the key weight becomes difficult to be pushed into the weight accommodating portion, which results in an increase in time and labor for mounting the key weight.

### SUMMARY OF THE INVENTION

It is a first object of the present invention to provide a key weight which can be easily mounted in a key and be positively prevented from falling off the key.

It is a second object of the present invention to provide a key for a keyboard instrument, to which the above key weight is stably fixed.

To attain the above first object, in a first aspect of the present invention, there is provided a key weight that is made of an elastic material and is mounted in a key for a keyboard instrument by being inserted from outside into a weight-accommodating portion formed in the key, including a weight body that is formed into a block shape, a guide portion that is provided on a front side of the weight body and extends not only in a vertical direction but also further downward than a front surface of the weight body by a predetermined length, and a pair of left and right first latched portions that are provided at respective lower portions of opposite left and right side surfaces of the guide portion and are latched with key-side latching portions provided in the weight-accommodating portion, and wherein during insertion of the key weight into the weight-accommodating portion, when the key weight is pushed into the weight-accommodating portion in a state in which the pair of first latched portions are in contact with the key-side latching portions, a lower portion of the guide portion is elastically deformed by reaction forces from the key-side latching portions such that the lower portion is bent rearward, and is restored by disappearance of the reaction forces, whereby the first latched portions are latched with the key-side latching portions from below.

According to this construction, the key weight made of the elastic material includes the weight body, the guide portion, and the pair of first latched portions. When this key weight is mounted in the key, the key weight is inserted into the weight-accommodating portion. During this insertion, when the key weight is pushed into the weight-accommodating portion in the state in which the pair of first latched portions of the key weight are in contact with the key-side latching portions of the weight-accommodating portion, the lower portion of the guide portion is elastically deformed by reaction forces from the key-side latching portions such that the lower portion is bent rearward, and is restored by the disappearance of the reaction forces, whereby the first latched portions are latched with the key-side latching portions from below. As described above, when the key weight is mounted in the key, it is possible, while causing the lower portion of the guide portion to be bent by elastic deformation, to push the key weight into the weight-accommodating portion with a relatively small force, and easily mount the key weight in the key. Further, when the key weight is pushed into the weight-accommodating portion, since the first latched portions are caused to be latched with the key-side latching portions from below, it is possible to positively prevent the key weight from falling off the key.

Preferably, each of the first latched portions is formed into a tapered shape in which the first latched portion is progressively reduced in height dimension as the first latched portion extends forward.

With the construction of this preferred embodiment, since each of the first latched portions is formed into the tapered shape described above, the key weight is pushed into the weight-accommodating portion in the state in contact with the key-side latching portions, whereby it is possible to easily elastically deform the lower portion of the guide portion by reaction forces from the key-side latching portions such that the lower portion is bent rearward.

More preferably, the weight body has side surfaces thereof provided with second latched portions which are latched with side walls of the weight-accommodating portion.

With the construction of this preferred embodiment, when the key weight is inserted into the weight-accommodating portion, the second latched portions provided on the side surfaces of the weight body are latched with the side walls of the weight-accommodating portion. This makes it possible, in combination with the latching of the first latched portions of the guide portion with the key-side latching portions of the weight-accommodating portion, to securely fix the key weight inserted into the weight-accommodating portion to the weight-accommodating portion.

To attain the above second object, in a second aspect of the present invention, there is provided a key for a keyboard instrument, in which the key weight described above is mounted, wherein the key includes the weight-accommodating portion formed into a hollow shape open downward, and wherein the weight-accommodating portion includes the key-side latching portions which latch the first latched portions of the key weight by supporting the first latched portions from below in a state in which the key weight is accommodated in the weight-accommodating portion.

According to this construction, the weight-accommodating portion provided in the key is formed into the hollow shape open downward. The weight-accommodating portion is provided with the key-side latching portions. The key-side latching portions latch the first latched portions of the key weight accommodated in the weight-accommodating portion with the key-side latching portions by supporting the first latched portions from below. With this, it is possible to easily obtain the key in which the key weight is securely mounted in the state accommodated in the weight-accommodating portion.

More preferably, the key-side latching portions are formed by a pair of left and right key-side latching portions that are arranged with a predetermined spacing therebetween in a left-right direction, and latch the pair of first latched portions, respectively.

According to the construction of this preferred embodiment, the key-side latching portions are formed by the pair of left and right key-side latching portions which are arranged with the predetermined spacing therebetween in the left-right direction, and the pair of key-side latching portions latch the pair of left and right first latched portions of the key weight. Therefore, a front-side lower portion of the key weight can be latched from both of the left and the right side in a well balanced state.

The above and other objects, features, and advantages of the present invention will become more apparent from the following detailed description taken in conjunction with the accompanying drawings.

### BRIEF DESCRIPTION OF THE DRAWINGS

FIGS. 1A to 1E are views of a key for a keyboard instrument, which has a key weight according to an embodiment of the present invention mounted therein, in which FIG. 1A is an appearance perspective view of the key, FIG. 1B is a longitudinal cross-sectional view of the key, FIG. 1C is a cross-sectional view taken along line c-c of FIG. 1B, FIG. 1D is a cross-sectional view taken along line d-d of FIG. 1B, and FIG. 1E is a cross-sectional view corresponding to FIG. 1D, in which ridges of second latched portions of the key weight in a state not elastically deformed are indicated by two-dot chain lines;

FIG. 2 is a perspective view of a weight-accommodating portion of a black key, as viewed obliquely from below, and the key weight before being mounted in the key;

FIGS. 3A to 3D are views of the key weight, in which FIG. 3A is a perspective view of the key weight, as viewed obliquely from right above, FIG. 3B is a perspective view of the key weight, as viewed obliquely from left above, FIG. 3C is a front view of the key weight, and FIG. 3D is a right side view of the key weight;

FIGS. 4A to 4D are views sequentially showing procedure steps of mounting the key weight in the black key; and

FIGS. 5A and 5B are views useful in explaining a variation of the key weight, in which FIG. 5A shows the key weight of the present embodiment, and FIG. 5B shows the variation of the key weight.

### DETAILED DESCRIPTION OF PREFERRED EMBODIMENTS

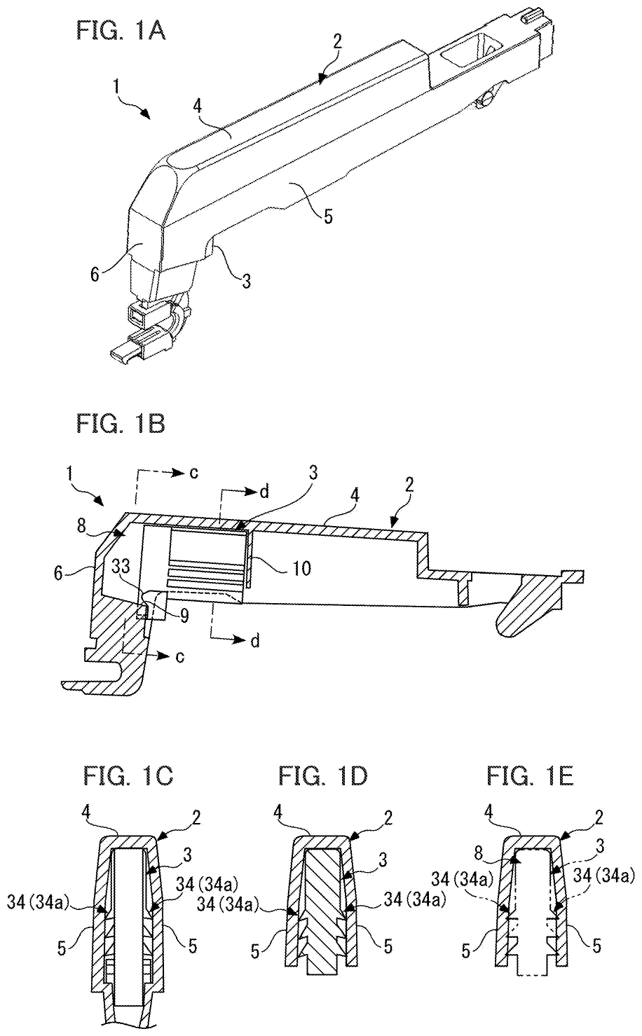

The present invention will now be described in detail with reference to the drawings showing a preferred embodiment thereof. FIGS. 1A to 1E show a key in which a key weight according to an embodiment of the present invention is mounted. As shown in FIGS. 1A to 1E, this key 1 is a black key used in a keyboard device for a keyboard instrument, such as an electronic piano, which is formed by arranging a multiplicity of (e.g. 88) keys 1, together with white keys, not shown, in parallel in a left-right direction. The key 1 includes a key body 2 extending in a front-rear direction (left-right direction in FIG. 1B) and the key weight 3 mounted in the key body 2.

The key body 2 is made of a predetermined kind of synthetic resin (e.g. an AS resin) and is formed as a molded article having a predetermined shape extending in the front-rear direction. Specifically, the key body 2 includes a horizontal top wall 4, left and right side walls 5 and 5 vertically extending downward from opposite left and right ends of the top wall 4, respectively, and a front wall 6 provided on front ends of the top wall 4 and the left and right side walls 5 and 5.

Further, the key body 2 has a front portion thereof provided with a weight-accommodating portion 8 for mounting the key weight 3 in the key body 2 in a state accommodated in the weight-accommodating portion 8. The weight-accommodating portion 8 is formed into a hollow shape open downward. Specifically, the weight-accommodating portion 8 having a predetermined size is defined by the top wall 4, the left and right side walls 5 and 5, the front wall 6, and a rear wall 10 provided at a predetermined location rearward of the front wall 6.

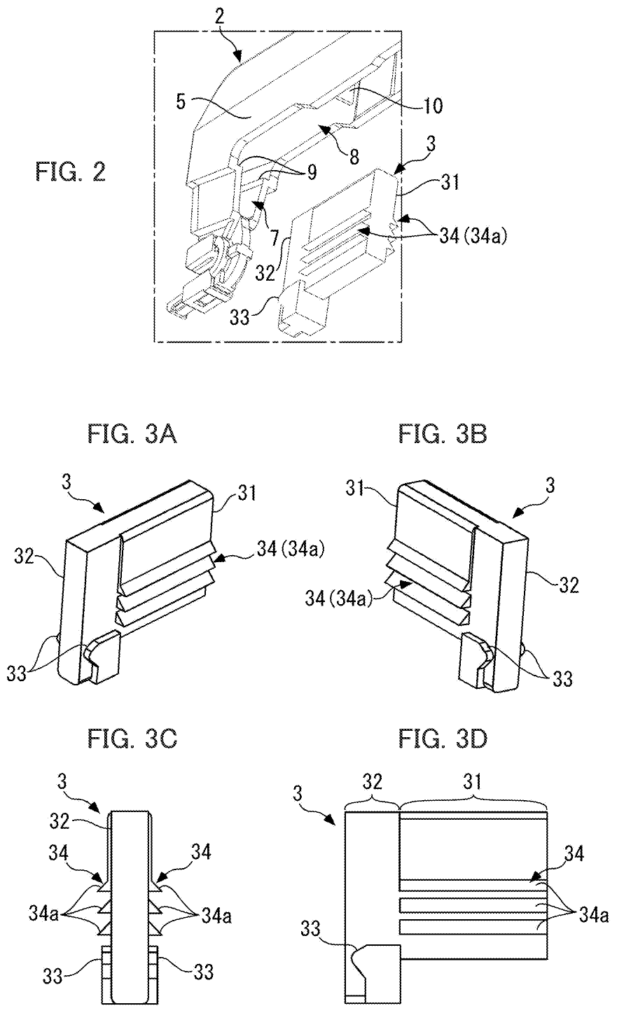

Further, as shown in FIGS. 1B and 2, the weight-accommodating portion 8 has a front portion thereof provided with a pair of left and right latching portions 9 and 9 (key-side latching portions). Each latching portion 9 is formed into a state in which a predetermined portion of an associated one of the side walls 5 and 5 slightly protrudes inward. Further, the key body 2 has a guide groove 7 formed between and below the above-mentioned pair of latching portions 9 and 9. When the key weight 3 is inserted into the weight-accommodating portion 8, a guide portion 32, referred to hereinafter, of the key weight 3 is inserted into the guide groove 7. The guide groove 7 is provided for guiding the inserted guide portion 32 into the weight-accommodating portion 8.

FIGS. 3A to 3D show the key weight 3. FIGS. 3A and 3B are perspective views of the key weight 3, as viewed obliquely from right above, and as viewed obliquely from left above, respectively. FIG. 3C is a front view, and FIG. 3D is a right side view. As shown in FIGS. 3A to 3D, the key weight 3 is made of an elastic material, such as a predetermined kind of rubber having a relatively large specific gravity, or rubber mixed with metal powder such as iron powder, and is formed as a resin molded article having a predetermined shape. Specifically, the key weight 3 includes a weight body 31 formed into a block shape, the guide portion 32 formed forward of the weight body 31 and vertically extending further downward than a front surface of the weight body 31 by a predetermined length, a pair of left and right first latched portions 33 and 33 that are provided at respective lower portions of opposite left and right side surfaces of the guide portion 32 and are latched with the latching portions 9 and 9 of the weight-accommodating portion 8, and second latched portions 34 and 34 that protrude outward from opposite left and right side surfaces of the weight body 31, respectively, and are latched with the side walls 5 and 5 of the weight-accommodating portion 8.

The weight body 31 is formed into a rectangular parallelepiped shape approximately square in side view and having a predetermined thickness. The guide portion 32 is formed into a rectangular parallelepiped shape vertically elongated in side view and having substantially the same thickness as the weight body 31. Further, the guide portion 32 is formed such that it extends further downward from a bottom surface of the weight body 31 by a predetermined length.

Each first latched portion 33 protrudes outward from an associated one of side surfaces of the guide portion 32 by a predetermined thickness as a whole. Further, an upper half portion of the first latched portion 33 is formed such that it has a shape protruding forward in side view. More specifically, the upper half portion of the first latched portion 33 is formed into a tapered shape in which the first latched portion 33 is progressively reduced in height dimension as the first latched portion extends 33 forward.

Each second latched portion 34 is formed into a sawtooth shape in front view, as a whole, and is formed by three ridges 34a arranged side by side along the vertical direction. Each ridge 34a includes a sloped surface and a horizontal surface as respective upper and lower surfaces, and extends along the entirety of an associated side surface of the weight body 31 in a front-rear direction.

Note that FIG. 1E corresponds to FIG. 1D, and the key weight 3 before being accommodated in the weight-accommodating portion 8 is indicated by two-dot chain lines. As shown in FIG. 1E, in the key weight 3, the weight body 31 is formed to be smaller than the weight-accommodating portion 8, and an outer shape of the whole key weight 3 including the second latched portions 34 is formed to be slightly larger than the weight-accommodating portion 8.

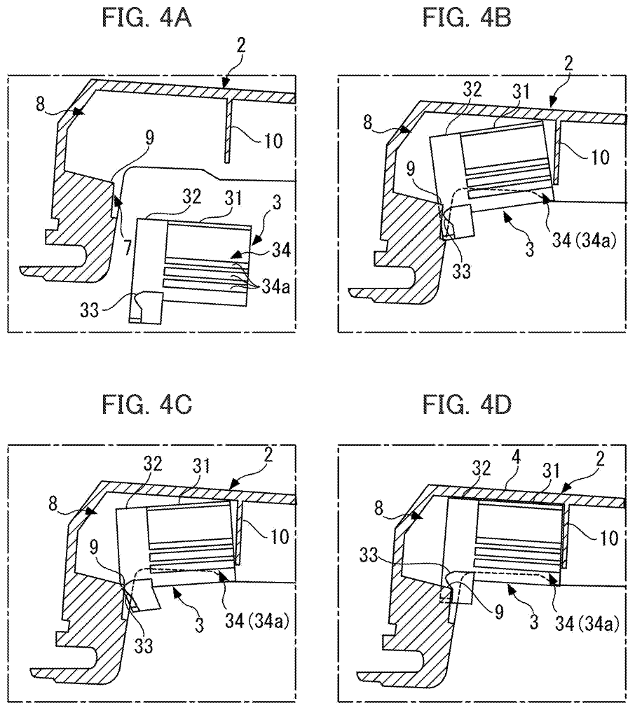

Here, a method of mounting the key weight 3 in the key body 2 will be described with reference to FIGS. 4A to 4D. FIG. 4A shows a state before the key weight 3 is inserted into the weight-accommodating portion 8. The key weight 3 is inserted into the weight-accommodating portion 8 from below the key body 2. When inserting the key weight 3 into the weight-accommodating portion 8, first, the guide portion 32 of the key weight 3 is inserted into the guide groove 7 of the key body 2, and the weight body 31 of the key weight 3 is inserted into the weight-accommodating portion 8.

FIG. 4B shows a state in which most part of the key weight 3 is accommodated in the weight-accommodating portion 8, and the first latched portions 33 and 33 are brought into contact with respective associated ones of the latching portions 9 and 9. Note that in this case, a rear end of an upper surface and a lower end of a rear surface of the weight body 31 of the key weight 3 are in a state contacting the top wall 4 and the rear wall 10 of the weight-accommodating portion 8, respectively. Further, in the left and right second latched portions 34 and 34 of the key weight 3, each ridge 34a receives a reaction force from an associated one of the side walls 5 of the weight-accommodating portion 8, whereby the ridge 34a is elastically deformed such that it is bent below.

When the key weight 3 is pushed into the weight-accommodating portion 8 from this state, as shown in FIG. 4C, a lower portion of the guide portion 32 of the key weight 3 receives reaction forces from the latching portions 9 of the weight-accommodating portion 8, and is elastically deformed such that the lower portion is bent rearward. Then, when the left and right first latched portions 33 and 33 of the key weight 3 get over the left and right latching portions 9 and 9, the reaction forces from the latching portions 9 disappear, whereby the elastically deformed lower portion of the guide portion 32 is restored. With this, as shown in FIG. 4D, the key weight 3 is properly accommodated in the weight-accommodating portion 8 of the key body 2, in the state in which the upper surface and the rear surface of the key weight 3 are in contact with the top wall 4 and the rear wall 10 of the weight-accommodating portion 8, respectively, and the pair of left and right first latched portions 33 and 33 are latched with the left and right latching portions 9 and 9 in a state supported by the left and right latching portions 9 and 9 from below.

As described in detail heretofore, according to the key weight 3 according to the present embodiment, when the key weight 3 is mounted in the key body 2, it is possible, while causing the lower portion of the guide portion 32 to be bent by elastic deformation, to push the key weight 3 into the weight-accommodating portion 8 with a relatively small force, and easily mount the key weight 3 in the key body 2. Further, when the key weight 3 is pushed into the weight-accommodating portion 8, since the left and right first latched portions 33 and 33 are caused to be latched with the latching portions 9 and 9 in a state supported from below by the latching portions 9 and 9, it is possible to positively prevent the key weight 3 from falling off the key body 2.

Further, when the key weight 3 is inserted into the weight-accommodating portion 8, the ridges 34a of the second latched portions 34 and 34 on the opposite left and right sides of the weight body 31 are elastically deformed downward, and the weight body 31 is latched with the left and right side walls 5 and 5 of the weight-accommodating portion 8 by thrust due to the returning forces of the ridges 34a. This makes it possible, in combination with the latching of the first latched portions 33 and 33 of the guide portion 32 with the latching portions 9 and 9 of the weight-accommodating portion 8, to securely fix the key weight 3 inserted into the weight-accommodating portion 8 to the weight-accommodating portion 8.

Further, according to the key 1 of the present embodiment, the above-described key weight 3 is accommodated in the weight-accommodating portion 8 having the hollow shape open downward, and is latched with the latching portions 9 and 9 formed on the weight-accommodating portion 8 in the state supported from below by the latching portions 9 and 9, and therefore, it is possible to easily obtain the key 1 which has the key weight 3 securely mounted therein in the state accommodated in the weight-accommodating portion 8.

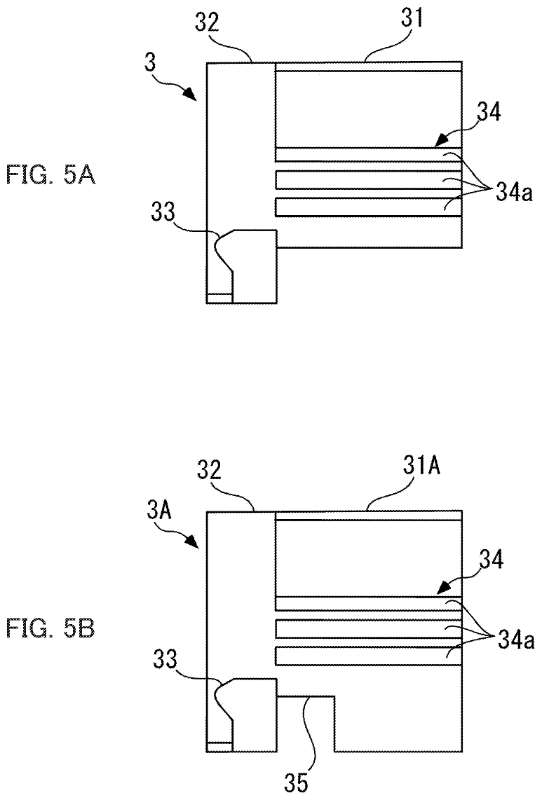

Note that the present invention is not limited to the above-described embodiment, but it can be practiced in various forms. FIG. 5A is a right side view of the above-described key weight 3, and FIG. 5B is a right side view of a key weight 3A which is a variation of the key weight 3. As shown in FIGS. 5A and 5B, the key weight 3A according to the variation is different from the key weight 3 only in that a weight body 31A is formed such that it has approximately the same height dimension as the guide portion 32, and includes a cutout 35 having a predetermined size at a location rearward of the first latched portions 33 and 33. In the key weight 3A, the above-mentioned cutout 35 functions to receive the lower portion of the guide portion 32, whereby when the key weight 3A is mounted in the key body 2, similar to the key weight 3, described above with reference to FIG. 4C, the lower portion of the guide portion 32 can be elastically deformed such that the lower portion is bent rearward.

Further, details of the constructions of the key weight 3 and the key weight 3A according to the variation shown in the embodiment are given only by way of example, and they can be modified as appropriate within the scope of the subject matter of the present invention.

It is further understood by those skilled in the art that the foregoing are preferred embodiments of the invention, and that various changes and modifications may be made without departing from the spirit and scope thereof.

What is claimed is:

1. A key weight that is made of an elastic material and is mounted in a key for a keyboard instrument by being inserted from outside into a weight-accommodating portion formed in the key comprising:
a weight body that is formed into a block shape;
a guide portion that is provided on a front side of the weight body and extends not only in a vertical direction but also further downward than a front surface of the weight body by a predetermined length; and
a pair of left and right first latched portions that are provided at respective lower portions of opposite left and right side surfaces of the guide portion and are latched with key-side latching portions provided in the weight-accommodating portion, and
wherein during insertion of the key weight into the weight-accommodating portion, when the key weight is pushed into the weight-accommodating portion in a state in which the pair of first latched portions are in contact with the key-side latching portions, a lower portion of the guide portion is elastically deformed by reaction forces from the key-side latching portions such that the lower portion is bent rearward, and is restored by disappearance of the reaction forces, whereby the first latched portions are latched with the key-side latching portions from below.

2. The key weight according to claim 1, wherein each of the first latched portions is formed into a tapered shape in which the first latched portion is progressively reduced in height dimension as the first latched portion extends forward.

3. The key weight according to claim 2, wherein the weight body has side surfaces thereof provided with second latched portions which are latched with side walls of the weight-accommodating portion.

4. A key for a keyboard instrument, in which the key weight as claimed in claim 1 is mounted,
wherein the key includes the weight-accommodating portion formed into a hollow shape open downward, and
wherein the weight-accommodating portion includes the key-side latching portions which latch the first latched portions of the key weight by supporting the first latched portions from below in a state in which the key weight is accommodated in the weight-accommodating portion.

5. The key according to claim 4, wherein the key-side latching portions are formed by a pair of left and right key-side latching portions that are arranged with a predetermined spacing therebetween in a left-right direction, and latch the pair of first latched portions, respectively.
